(19) United States
(12) Patent Application Publication
(10) Pub. No.: US 2011/0236727 A1
(43) Pub. Date: Sep. 29, 2011

(54) SECONDARY BATTERY PACK

(76) Inventor: Young-Cheol Jang, Yongin-si (KR)

(21) Appl. No.: 12/973,595

(22) Filed: Dec. 20, 2010

Related U.S. Application Data
(60) Provisional application No. 61/318,740, filed on Mar. 29, 2010.

(51) Int. Cl. H01M 10/42

(52) U.S. Cl. 429/7

(57) ABSTRACT

A secondary battery pack includes a battery cell having an electrode assembly, a case housing the electrode assembly, and a first electrode tab and a second electrode tab electrically coupled to the electrode assembly; and a protection circuit module coupled to the battery cell, wherein the protection circuit module includes a printed circuit substrate; and a temperature safety device embedded in the printed circuit substrate.

### CROSS-REFERENCE TO RELATED APPLICATION

This application claims the benefit of U.S. Provisional Application No. 61/318,740, filed on Mar. 29, 2010, in the United States Patent and Trademark Office, the entire disclosure of which is incorporated herein in its entirety by reference.

### BACKGROUND

1. Field

One or more embodiments of the present invention relate to a secondary battery pack.

2. Description of Related Art

In general, secondary batteries refer to batteries that are dischargeable and rechargeable, unlike primary batteries that are not rechargeable. Secondary batteries are used as energy sources for mobile devices, such as notebook computers, mobile phones, electric vehicles, hybrid electric vehicles, electric bicycles, and uninterruptible power supply devices.

Secondary battery packs typically include a safety device assembly. Examples of a safety device assembly include a temperature safety device, a safety vent, a current interrupt device, a thermal fuse, and a shut-down separator.

Among safety elements, the temperature safety device cuts off current by increasing the resistance of the temperature safety device when the temperature of a secondary battery exceeds a set temperature.

### SUMMARY

One or more embodiments of the present invention include a secondary battery pack that improves the heat transfer efficiency of a battery cell by allowing a temperature safety device to be easily electrically coupled to an electrode tab of the battery cell.

According to one or more embodiments of the present invention, a secondary battery pack includes a battery cell having an electrode assembly, a case housing the electrode assembly, and a first electrode tab and a second electrode tab electrically coupled to the electrode assembly; and a protection circuit module coupled to the battery cell, wherein the protection circuit module includes a printed circuit substrate; and a temperature safety device embedded in the printed circuit substrate.

In one embodiment, the temperature safety device is thermally coupled to the first electrode tab or the second electrode tab. Further, a metal plate may be located on the printed circuit substrate, wherein the temperature safety device is electrically coupled to the first electrode tab or the second electrode tab via the plate.

The printed circuit substrate may include at least one opening between the plate and the temperature safety device, the opening containing a conductive material, such as solder cream. In one embodiment, a surface of the temperature safety device is substantially flush with a surface of the printed circuit substrate and in another embodiment there is a space between the temperature safety device and the printed circuit substrate.

### BRIEF DESCRIPTION OF THE DRAWINGS

FIG. 1 is a partially exploded perspective view of a battery cell according to an embodiment of the present invention;

FIG. 2 is a partially exploded perspective view of a secondary battery pack including a protection circuit module coupled to the battery cell of FIG. 1, according to an embodiment of the present invention;

FIG. 3 is a cross-sectional view illustrating a temperature safety device embedded in a printed circuit substrate of the secondary battery pack of FIG. 2, according to an embodiment of the present invention;

FIG. 4 is a cross-sectional view illustrating a temperature safety device embedded in a printed circuit substrate of the secondary battery pack of FIG. 2, according to another embodiment of the present invention;

FIG. 5 is an exploded perspective view of a secondary battery pack according to another embodiment of the present invention;

FIG. 6 is a cross-sectional view of a modification of FIG. 1, illustrating a temperature safety element embedded in a printed circuit substrate of the secondary battery pack according to another embodiment of the present invention;

FIG. 7 is a graph illustrating a result of an overcharge test performed on a conventional secondary battery pack including a conventional temperature safety device; and

FIG. 8 is a graph illustrating a result of an overcharge test performed on the secondary battery pack including the temperature safety device of FIG. 2.

### DETAILED DESCRIPTION

Reference will now be made in detail to embodiments, examples of which are illustrated in the accompanying drawings.

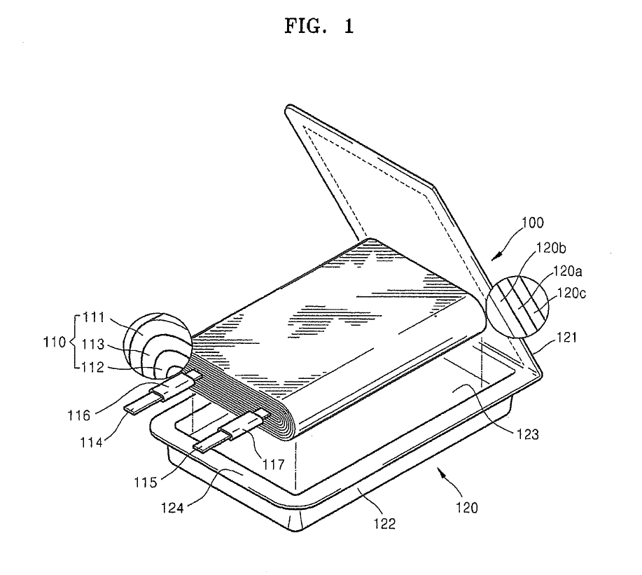

FIG. 1 is an exploded perspective view of a battery cell 100 according to an embodiment of the present invention.

Referring to FIG. 1, the battery cell 100, which may be a lithium polymer battery cell, includes an electrode assembly 110, and a case 120 in which the electrode assembly 110 is received. The electrode assembly 110 includes a positive electrode plate 111, a negative electrode plate 112, and a separator 113 located between the positive electrode plate 111 and the negative electrode plate 112.

A positive electrode tab 114 is electrically coupled to the positive electrode plate 111. A positive electrode insulating tape 116 is wound around the positive electrode tab 114. A negative electrode tab 115 is electrically coupled to the negative electrode plate 112. A negative electrode insulating tape 117 is wound around the negative electrode plate 115.

The case 120 includes a metal foil 120a, and insulating films 120b and 120c formed on both surfaces of the metal foil 120a. The case 120 is a flexible pouch-type case. The case 120 includes an upper case 121, and a lower case 122 coupled to the upper case 121. The upper case 121 and the lower case 122 are integrally formed at least one edge thereof to have a hinged configuration.

The electrode assembly 110 is located in a space portion 123 of the case 120. The positive electrode insulating tape 116 and the negative electrode insulating tape 117 are thermally bonded to a sealing surface 124 of the case 120. An end of the positive electrode tab 114 and an end of the negative electrode tab 115 are exposed to the outside of the case 120 that is sealed.

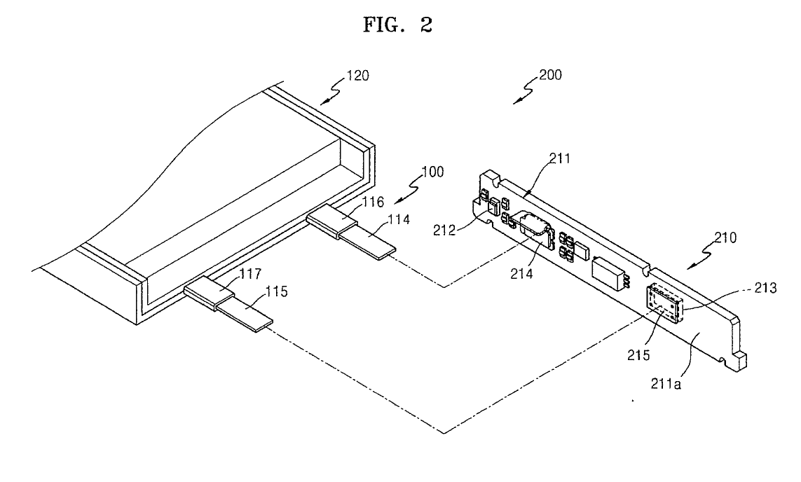

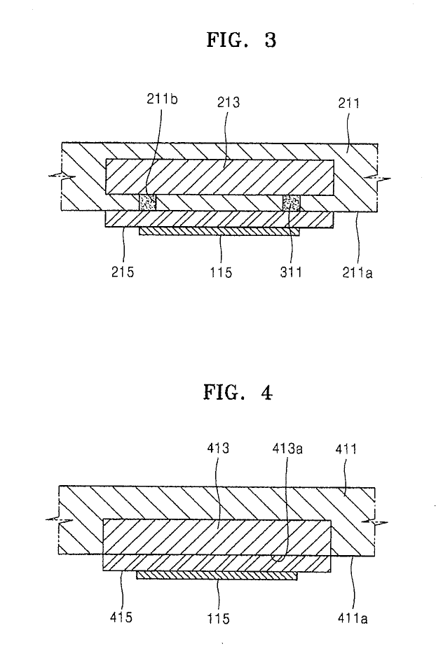

FIG. 2 is an exploded perspective view of a secondary battery pack 200 including a protection circuit module (PCM) 210 that is coupled to the battery cell 100 of FIG. 1, according to an embodiment of the present invention. FIG. 3 is a cross-sectional view illustrating a temperature safety device 213 embedded in a printed circuit substrate 211 of the secondary battery pack 200 of FIG. 2, according to an embodiment of the present invention.

The same elements as those in FIG. 1 are denoted by the same reference numerals. Although a secondary battery is a pouch-type secondary battery in FIGS. 1 through 3, the present embodiment is not limited thereto, and the secondary battery may also be, among others, a polygonal secondary battery formed of a thick metal material or a cylindrical secondary battery formed of a thick metal material.

Referring to FIGS. 2 and 3, the PCM 210 includes the printed circuit substrate 211, a plurality of electronic devices 212 mounted on the printed circuit substrate 211, and the temperature safety device 213 acting as a safety device. For example, the temperature safety device may be a positive temperature coefficient device or a thermal fuse.

The printed circuit substrate 211 is a circuit substrate formed by stacking one or more circuit pattern layers. Examples of the electronic devices 212 may include integrated circuit (IC) chips, field effect transistors (FETs), resistors, and capacitors.

The temperature safety device 213 includes a polymer with conductive particles.

A polymer-based conductive composite may be a mixture of a polymer, a conductive filler, an antioxidant, and a crosslinking agent containing peroxide. The polymer may be a polymer with a melt index of 1 to 10 such as high-density polyethylene (HDPE), low-density polyethylene (LDPE), polyvinylidene fluoride (PVDF), polypropylene (PP) or ethylene/polypropylene polymer.

The conductive filler may be a carbon black, a carbon fiber, a metal such as nickel, or a metal oxide filler.

While the polymer is generally an insulating material, the polymer has high conductivity since the temperature safety device 213 provides a conductive path when conductive particles are interconnected at room temperature or high temperature due to the conductive filler.

If the temperature of the battery cell 100 is increased to exceed a specific temperature, or if over-current flows, the polymer included in the temperature safety device 213 expands and a distance between the conductive particles is increased to shut down the conductive path. The temperature safety device 213 may be operated under normal conditions by creating a space in the printed circuit substrate 211 in which the temperature safety device 213 is buried or embedded as the polymer included in the temperature safety device 213 expands. As will be appreciated, the temperature safety device embedded in the printed circuit substrate 211 may contact the printed circuit substrate on all sides or may be spaced from the printed circuit substrate at one or more sides.

The positive electrode tab 114 protruding from the case 120 is electrically coupled to a first terminal 214 formed on the printed circuit substrate 211. The positive electrode tab 115 protruding from the case 120 is electrically coupled to the temperature safety device 213 formed in the printed circuit substrate 211.

The temperature safety device 213 is embedded in one surface 211a of the printed circuit substrate 211 facing the negative electrode tab 115, as explained in detail below.

The temperature safety device 213 is embedded in the printed circuit substrate 211. More specifically, the temperature safety device 213 is embedded to a certain depth from one surface 211a of the printed circuit substrate 211 facing the negative electrode tab 115. The temperature safety device 213 is located to generally be aligned with the negative electrode tab 115.

A metal plate 215 is installed between the temperature safety device 213 and the negative electrode tab 115. In one embodiment, the metal plate 215 is attached to one surface 211a of the printed circuit substrate 211 to generally be aligned with the temperature safety device 213. The negative electrode tab 115 may be spot-welded or otherwise fixed to a top surface of the metal plate 215. The metal plate 215 may be formed of a metal material having high conductivity. For example, the metal plate 215 may be a nickel plate.

The metal plate 215 is electrically coupled to the temperature safety device 213 via openings 211b. That is, the openings 211b are formed to extend from the one surface 211a of the printed circuit substrate 211 to a surface of the temperature safety device 213. A conductive material 311, such as a solder cream, is filled in the openings 211b.

Accordingly, a bottom surface of the metal plate 215 is electrically coupled to the temperature safety device 213 due to the conductive material 311. The top surface of the metal plate 215 is electrically coupled to the negative electrode tab 115.

In the secondary battery pack 200 constructed as described above, if the temperature of the electrode assembly 110 of the battery cell 100 is increased during operation, heat is transferred sequentially through the battery cell 100, the negative electrode tab 115, the metal plate 215, the conductive material 311, and the temperature safety device 213.

If the temperature of the battery cell 100 is increased to exceed a reference temperature, for example, 80° C., the resistance of the temperature safety device 213 is increased to cut off current. Accordingly, damage to the battery cell 100 may be significantly prevented.

FIG. 4 is a cross-sectional view illustrating a temperature safety device 413 embedded in a printed circuit substrate 411 of the secondary battery pack 200 of FIG. 2, according to another embodiment of the present invention.

Referring to FIG. 4, the temperature safety device 413 is embedded in the printed circuit substrate 411, but the temperature safety device 413 is not completely embedded in the printed circuit substrate 411 unlike in FIG. 3, and one surface 413a of the temperature safety device 413 is exposed from the printed circuit substrate 411. The one surface 413a of the temperature safety device 413 is generally aligned with one surface 411a of the printed circuit substrate 211.

A metal plate 415 is installed between the one surface 413a of the temperature safety device 413 and the negative electrode tab 115. A bottom surface of the metal plate 415 is directly electrically coupled to the one surface 413a of the temperature safety device 413. A top surface of the metal plate 415 is spot-welded to the negative electrode tab 115.

The temperature safety device 413 constructed as described above selectively cuts off the flow of current by detecting the temperature of the battery cell 100 (see FIG. 1) when it is increased due to heat transferred through the negative electrode tab 115 and the metal plate 415,

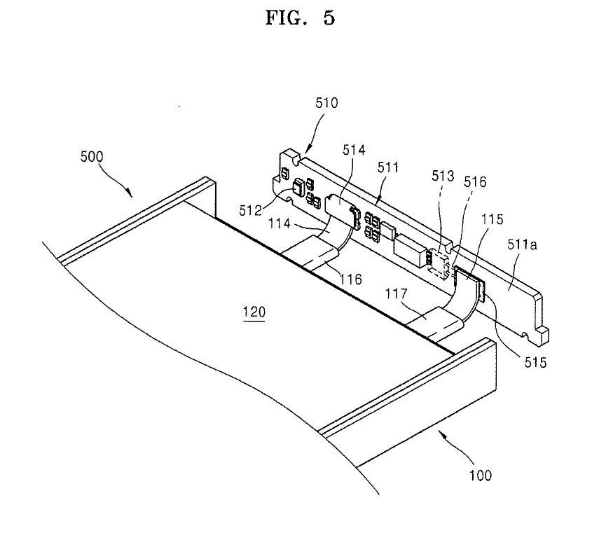

FIG. 5 is an exploded perspective view of a secondary battery pack 500 according to another embodiment of the present invention.

Referring to FIG. 5, a protection circuit module 510 includes a printed circuit substrate 511, a plurality of electronic devices 512 mounted on the printed circuit substrate 511, and a temperature safety device 513.

The positive electrode tab 114 protruding from the case 120 is electrically coupled to a first terminal 514 formed on the printed circuit substrate 511. The negative electrode tab 115 protruding from the case 120 is electrically coupled to the temperature safety device 513 formed in the printed circuit substrate 511.

The temperature safety device 513 is embedded in the printed circuit substrate 511. The temperature safety device 513 is embedded to a certain depth from one surface 511a of the printed circuit substrate 511 facing the negative electrode tab 115. The temperature safety device 513 is located so as not to be aligned with the negative electrode tab 115. That is, while the temperature safety device 213 or 413 is located to face the negative electrode tab 115 in FIGS. 3 and 4, the temperature safety device 513 does not face (i.e., is not aligned with) the negative electrode tab 115 in FIG. 5.

The negative electrode tab 115 is electrically coupled to a second terminal 515 formed on the printed circuit substrate 511. The temperature safety device 513 is electrically coupled to the second terminal 515 by circuit wiring 516. The circuit wiring 516 is embedded in the printed circuit substrate 511, and one end of the circuit wiring 516 is connected to the temperature safety device 513 and the other end of the circuit wiring 516 is connected to the second terminal 515.

Alternatively, the temperature safety device 513 may be connected to the negative electrode tab 115 without a metal plate. For example, the temperature safety device 513 may be connected to the negative electrode tab 115 by the circuit wiring 516 that is patterned on the printed circuit substrate 511 without the second terminal 515.

The temperature safety device 513 constructed as described above selectively cuts off the flow of current by detecting the temperature of the battery cell 100 which is increased due to heat transferred through the second terminal 515 and the circuit wiring 516.

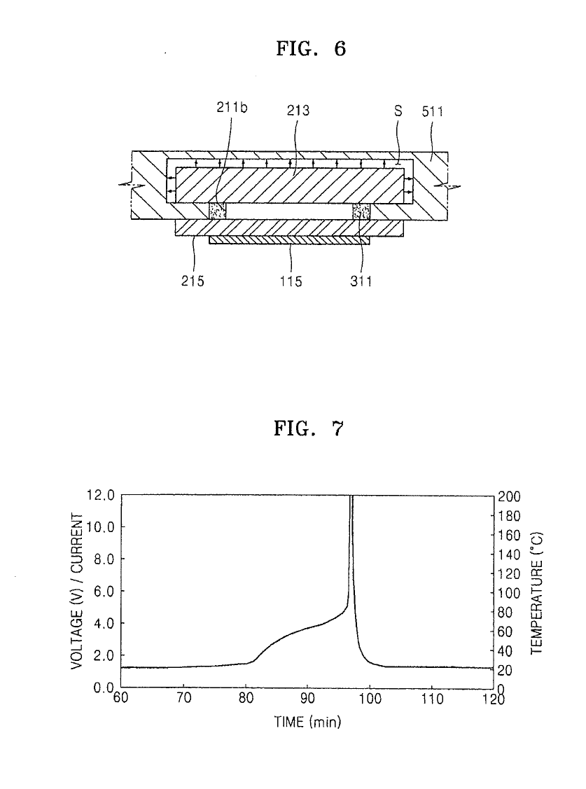

FIG. 6 is a cross-sectional view of a modification of FIG. 1, illustrating a temperature safety element 213 embedded in a printed circuit substrate 511 of the secondary battery pack 500, according to an embodiment of the present invention. Referring to FIG. 6, a predetermined free space S is created between the printed circuit substrate 511 and the temperature safety element 213. The temperature safety element 213 buried in the printed circuit substrate 511 may undergo volume expansion as the polymer included in the temperature safety element 213 expands, and the free space S receives the expanded temperature safety element 213, thereby enabling the temperature safety element 213 to operate normally.

Although the temperature safety device is electrically coupled to the electrode tab 115 as shown in FIGS. 2 to 6, the embodiments are not limited thereto. That is, the temperature safety device may be connected to a positive electrode tab without departing from the scope of the embodiments of the present invention.

In an embodiment, a positive electrode tab and a negative electrode tab may be electrically connected to an external terminal through a switch device (not shown) for selectively turning on/off of the battery cell 100, and a battery management system (BMS, not shown) for monitoring and controlling states of charge and discharge of the battery cell 100. Here, the external terminal, to which a terminal of an external power supply device or a power terminal of an external load may be electrically connected, may be formed on the printed circuit substrate.

The switch device performs a switching function for selectively turning on or off the charge and discharge operation of the battery cell 100, and may include a field-effect transistor (FET). However, the present embodiment is not limited thereto, and the switch device may be an electrical device for performing other types of switching functions.

In order to protect the battery cell 100, the BMS may receive state information such as information about a charge/discharge voltage or current, and if the battery cell 100 shows abnormality such as overcharge or over-discharge, the BMS may turn off the switch device. The switch device and the BMS may be mounted on the printed circuit substrate or separately provided from the printed circuit substrate.

The results of an overcharge test performed using a conventional secondary battery and a secondary battery according to an embodiment of the present invention will now be explained.

FIG. 7 is a graph illustrating a result of an overcharge test performed on a conventional secondary battery pack including a conventional temperature safety device. FIG. 7 is a graph illustrating a result of an overcharge test performed on the secondary battery pack 200 including the temperature safety device 213 of FIG. 2.

The conventional secondary battery pack is configured in such a manner that the conventional temperature safety device and an electrode terminal are mounted on a printed circuit substrate to be exposed, and the conventional temperature safety device and the electrode terminal are connected by circuit wiring, and an electrode tab of a battery cell is connected to the electrode terminal. Accordingly, heat is transferred sequentially through the electrode tab of the battery cell, the electrode terminal of the printed circuit substrate, the circuit wiring, and the conventional temperature safety device.

The secondary battery pack 200 of the present embodiment is configured in such a manner that the temperature safety device 213 is embedded in the printed circuit substrate 211, the temperature safety device 213 is electrically coupled to the metal plate 215 by the conductive material 311 filled in the openings 211b, and the negative electrode tab 115 of the battery cell is connected to the metal plate 215. Accordingly, heat is transferred sequentially through the negative electrode tab 115, the metal plate 215, the conductive material 311, and the temperature safety device 213.

Referring to FIG. 7, because the conventional temperature safety device for detecting the temperature of the battery cell that may increase during operation may not detect the temperature of the battery cell until it is well above a set temperature, such as 80° C., the conventional temperature safety device may fail to cut off current when the temperature of the battery cell reaches the set temperature of 80° C., thus allowing the temperature to be increased to 200° C., which can be hazardous. For example, it has been found that the battery cell may explode when the temperature reaches about 120° C.

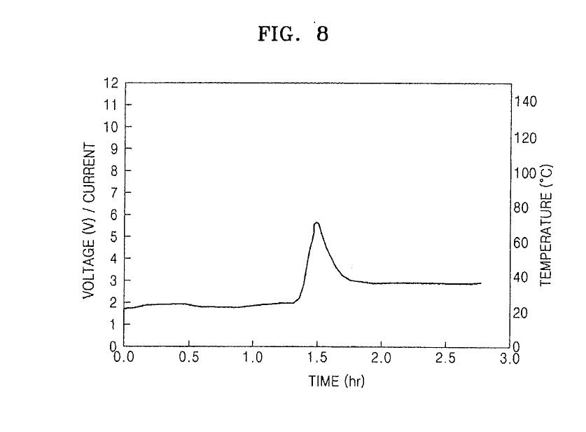

Referring to FIG. 8, in the case of the secondary battery pack 200, the temperature safety device 213 operates to detect the temperature of the battery cell 100 that may increase during operation and cut off the flow of current when the temperature of the battery cell reaches a set temperature of 80° C. Accordingly, the battery cell 100 is prevented from exploding.

As described above, since the secondary battery pack according to one or more embodiments of the present invention allows the temperature safety device to be embedded in the printed circuit substrate that is electrically coupled to the negative electrode tab of the battery cell, heat transfer efficiency of the battery cell is improved. That is, in order to most effectively operate the temperature safety device, close to 100% of the heat generated in the battery cell should be transferred to the temperature safety device, and accordingly, the temperature safety device can be located to be aligned with and relatively close to the negative electrode tab. Because heat may be dissipated if the temperature safety device is exposed to the outside of the printed circuit substrate, the temperature safety device can be buried in the printed circuit substrate to improve heat transfer efficiency.

While one or more embodiments of the present invention have been particularly shown and described, it should be understood that there may be may equivalents and modified embodiments that may substitute those described in this specification. Accordingly, the technical scope of the present disclosure is defined by the following claims and their equivalents.

What is claimed is:

1. A secondary battery pack comprising:
a battery cell comprising an electrode assembly, a case housing the electrode assembly, and a first electrode tab and a second electrode tab electrically coupled to the electrode assembly; and
a protection circuit module coupled to the battery cell, wherein the protection circuit module comprises:
a printed circuit substrate; and
a temperature safety device embedded in the printed circuit substrate.

2. The secondary battery pack of claim 1, wherein the temperature safety device is thermally coupled to the first electrode tab or the second electrode tab.

3. The secondary battery pack of claim 1, further comprising a plate on the printed circuit substrate, wherein the temperature safety device is electrically coupled to the first electrode tab or the second electrode tab via the plate.

4. The secondary battery pack of claim 3, wherein the printed circuit substrate has at least one opening between the plate and the temperature safety device, the opening containing a conductive material.

5. The secondary battery pack of claim 4, wherein the conductive material is a solder cream.

6. The secondary battery pack of claim 3, wherein the plate is metal.

7. The secondary battery pack of claim 6, wherein the metal comprises nickel.

8. The secondary battery pack of claim 3, wherein a location of the plate generally corresponds to a location of the temperature safety device.

9. The secondary battery pack of claim 3, wherein the plate directly contacts the temperature safety device.

10. The secondary battery pack of claim 3, wherein the plate is offset from the temperature safety device and wherein the temperature safety device is electrically coupled to the plate by circuit connector.

11. The secondary battery pack of claim 10, wherein the circuit connector is embedded in the printed circuit substrate.

12. The secondary battery pack of claim 3, wherein the first electrode tab or second electrode tab contacts the plate by a weld.

13. The secondary battery pack of claim 1, wherein the temperature safety device comprises a polymer-based conductive composite.

14. The secondary battery pack of claim 13, wherein the composite comprises a polymer and a conductive filler.

15. The secondary battery pack of claim 13, wherein the polymer comprises high-density polyethylene, low-density polyethylene, polyvinylidene fluoride, polypropylene or ethylene/polypropylene polymer.

16. The secondary battery pack of claim 13, wherein the conductive filler comprises carbon black, a carbon fiber, a metal or a metal oxide filler.

17. The secondary battery pack of claim 1, wherein a surface of the temperature safety device is substantially flush with a surface of the printed circuit substrate.

18. The secondary battery pack of claim 1, wherein there is a space between the temperature safety device and the printed circuit substrate.

19. A protection circuit module for a secondary battery pack, the protection circuit module comprising:
a printed circuit substrate; and
a temperature safety device embedded in the printed circuit substrate.

20. The protection circuit module of claim 19, further comprising a plate electrically coupled to the temperature safety device.
